(19) United States
(12) Patent Application Publication
(10) Pub. No.: US 2019/0073273 A1
(43) Pub. Date: Mar. 7, 2019

(54) Data Backup Software Application

(71) Applicant: Phillippe Lorson, Wayne, NJ (US)

(72) Inventor: Phillippe Lorson, Wayne, NJ (US)

(21) Appl. No.: 15/697,351

(22) Filed: Sep. 6, 2017

(51) Int. Cl. G06F 11/14; G06F 3/06

(52) U.S. Cl. CPC G06F 11/1464; H04M 3/42178; G06F 11/1456; G06F 3/065

(57) ABSTRACT

A data transfer software application for transmitting data is provided. The data transfer software comprises a first electronic device and a second electronic device. A software program downloaded on the first electronic device and the second electronic device. Upon launching the software program, the software program automatically, instantly, and immediately downloads data from the first electronic device to the second electronic device.

### CLAIM OF PRIORITY

This patent application claims priority under 35 USC 119 (e) (1) from U.S. Provisional Patent Application Ser. No. 62/383,935 filed Sep. 6, 2016, of common inventorship herewith entitled, “Black Box,” which is incorporated herein by reference as though the same were set forth in its entirety.

### FIELD OF THE INVENTION

The present invention pertains to the field of data maintenance, and more specifically to the field of data backup software application for personal electronic devices to transmit data from one personal electronic device to another, such as from smartphones and tablets to laptops and computers as well as to a main frame server from any internet provider or application platform.

### BACKGROUND OF THE INVENTION

One the most explosive new technologies to come out in the last thirty five years is the cellular telephone. The basic concept of cellular phones began in the year of 1947 as telecommunications researchers sought ways to increase traffic capacity and frequency of mobile communication in police car radios. Nonexistent technology and stringent regulations postponed availability of cellular technology until cellular use became federally authorized in the year of 1982. As a result of this regulation, scientific advances and increased competition among telecommunications companies put the cellular telephone on the fast track. Today's use of these revolutionary devices has spread extensively as cell phones have evolved through technological advances into smartphones which are mini computers. Capable of keeping individuals abreast of the latest stock quotes, providing wireless Internet access, capturing photos and videos, enabling social networking and playing music and games, cellular smartphones have become practically indispensable to millions of people around the world.

Busy people keep all their personal and business contacts, records of texts, financial information, and web searches stored in their cell phones. With the simple touch of a button or a voice command, a number is instantly dialed without the user ever having to memorize a phone number. A work document is accessible in a matter of seconds. Unfortunately, such technological convenience presents a drawback when the smartphone is lost, stolen or damaged and as a result, important data is lost.

The prior art has put forth several designs for data backup software for personal electronic devices. Among these are:

US Patent Publication 2012/0330888 to Arnaldo Zael Cruz describes a data backup device built into a device charging mechanism to provide an automated data backup when a device is charged. Such a system results in regular data backups as most users consistently charge their devices such as their cell phones, smart phones, tablet computers, and the like. The charger and data backup device integrates into a wireless network to provide remote accessibility and additional backup options. The charger and data backup device is configured to move data between electronic devices from multiple manufacturers or between electronic devices having different operating systems.

US Patent Publication 2004/0153884 to Benjamin Fields and Sabrina Grandchamps describes an instruction set system or network for communication devices and other similar electronic devices that provides a process and means for storing and recalling information and for coordinating data stored on one of these devices with other digital storage means such as personal computers. The network provides a means to enable redundant storage and backup for data stored on these devices that is simple, automatic and requires as little user intervention as possible by way of employment of a specific set of software instructions stored on a semiconductor chip or chip set executable on the dedicated microprocessors controlling communication devices that allow wireless data acquisition through the use of both currently available and futuristic wireless networks.

US Patent Publication 2003/0134625 to Jun-Min Choi describes a data backup method on a network and a system embodying such method where a mobile phone in accordance with the present invention includes a memory part which stores data to be backed up as well as programs configured to transmit and retrieve the backup data by means of wireless circuits. A control part is configured to process a user request for a data backup operation and transmit or receive the backup data. A wireless circuit part is configured to convert the backup data processed by the control part into radio signals and transmit the same. The circuit part converts the received radio signals into data recognizable by the mobile phone, allowing a user of the mobile phone to easily backup data and retrieve the same.

None of these prior art references describe the present invention.

### SUMMARY OF THE INVENTION

It is an object of the present invention to provide a data transfer software application particularly developed to transmit data from one personal electronic device to another, such as from smartphones and tablets to laptops and computers as well as to a main frame server from any internet provider or application platform.

It is further object of the invention to provide a data transfer software application particularly developed to transmit data from one personal electronic device to another, in real time. As the data is collected and stored on the original device, it is immediately sent to a second device.

The present invention is a data transfer software application for transmitting data. The data transfer software application comprises a first electronic device and a second electronic device. A software program downloaded on the first electronic device and the second electronic device. Upon launching the software program, the software program automatically, instantly, and immediately downloads data from the first electronic device to the second electronic device.

In addition, the present invention includes a method for transmitting data. The method comprises providing a first electronic device, providing a second electronic device, downloading a software program on the first electronic device and the second electronic device, launching the software program, and automatically, instantly, and immediately downloads data from the first electronic device to the second electronic device.

The present invention further includes a data transfer software application for transmitting data. The data transfer software application comprising a first electronic device and a second electronic device. A software program is downloaded on the first electronic device and the second electronic device. The software program monitors the location and content of the first electronic device. Upon launching the software program, the software program automatically, instantly, and immediately downloads data from the first electronic device to the second electronic device. Particular data immediately transmitted and interchanged between the first electronic device and the second electronic device is selectable in a parameter setting, enabling defining of data items to be transmitted and stored.

### BRIEF DESCRIPTION OF THE DRAWINGS

FIG. 1 is a perspective view illustrating a data transfer software application, constructed in accordance with the present invention, installed on a smartphone, showing an initial login screen.

FIG. 2 is another perspective view illustrating the data transfer software application, constructed in accordance with the present invention, installed on a smartphone, showing available backup options once a user has logged in.

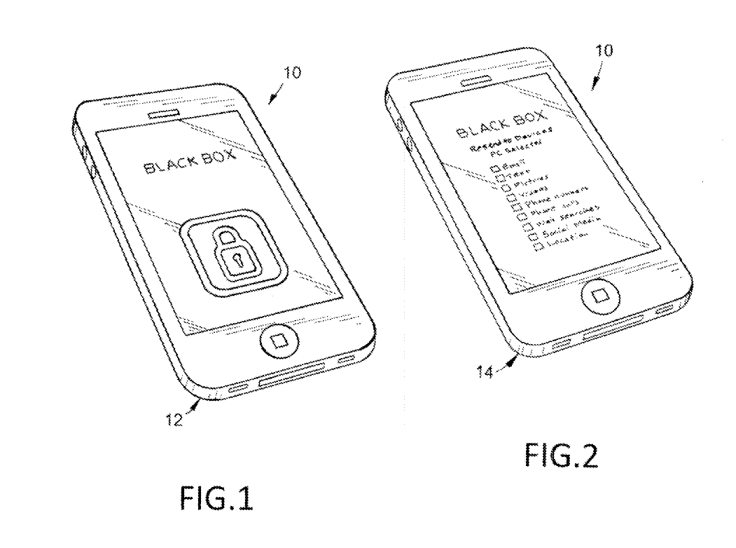

### DETAILED DESCRIPTION OF THE INVENTION

The present invention, hereinafter referred to as a Data Transfer Software Application 10, is a software application particularly developed to transmit data from one personal first electronic device 12 to another second electronic device 14, such as from smartphones and tablets to laptops and computers. The Data Transfer Software Application 10 application provides a simple, effective, instant backup system for immediate data restoration if a smartphone 12 user experiences data loss or their smartphone 12 becomes lost or stolen. Used to secure one's electronic property, the Data Transfer Software Application 10 also can function to monitor a personal electronic devices used by a minor or child.

Available through application distribution platforms such as the Apple App Store, Google Play, Windows Phone Store and BlackBerry App World, a user purchases and downloads the Data Transfer Software Application 10 of the present invention from an aforementioned platform to a target device such as an iPhone, iPad, Android phone, Windows Phone, or personal computer. The user installs the Data Transfer Software Application 10 on at least two devices referred to as device A 12 and device B 14. Device A 12 is the primary transmitting device. Device B 14 and subsequently defined devices, such as C, D and E, are receiving or recording devices. Commonly, the user designates their smartphone as device A 12 and their personal computer or tablet as device B 14. The user launches the Data Transfer Software Application 10 application by means of WiFi, cell towers, satellite, Bluetooth, or Cloud, whichever link appears first. Device B 14 and subsequently defined devices such as C, D, and E, are receiving or recording devices, but can also be the server from the cellular provider if no other device or web site is available. All of the instantly saved data can also be sent and stored by the application platform from, but not limited to, Apple app store, Google play, etc.

Upon wirelessly launching, the Data Transfer Software Application 10 of the present invention automatically links the defined devices 12, 14. Emails, texts, pictures, songs, videos, phone numbers, call records, web searches, fingerprints, and passcodes are immediately transmitted and interchangeable between the devices 12, 14. Each transmittable data category or item is selectable in a parameter setting, enabling the user to define which data items are to be transmitted and stored.

The Data Transfer Software Application 10 of the present invention links to a master web page which enables a user to switch designations between devices A 12 and B 14 as needed. The master web page stores all information from both devices 12, 14 and any subsequently added devices.

The Data Transfer Software Application 10 of the present invention provides a way for parents to monitor phone usage of minor children, checking on their whereabouts while also being able to protect them from dangers such as cyberbullying and online predators. Global Positioning System, generally called GPS, is utilized in case the primary Device A 12 is lost or stolen. A virtual ping is emitted from Device A 12 to Device B 14. The GPS location of Device A 12 displays on Device B 14 as long as Device A 12 has battery life. With so much data maintenance and processing capability between devices, users of the Data Transfer Software Application 10 no longer worry about they will lose vital information they need and use every day.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A data transfer software application for transmitting data, the data transfer software comprising:
a first electronic device;
a second electronic device; and
a software program downloaded on the first electronic device and the second electronic device;
wherein upon launching the software program, the software program automatically, instantly, and immediately downloads data from the first electronic device to the second electronic device.

2. The data transfer software application of claim 1 wherein the first electronic device is a smartphone.

3. The data transfer software application of claim 1 wherein the second electronic device is selected from the group consisting of a smartphone, a tablet, a laptop, and a computer.

4. The data transfer software application of claim 1 wherein the software program monitors the location and content of the first electronic device.

5. The data transfer software application of claim 1 and further comprising:
at least one additional electronic device, the software program downloaded on the at least one additional electronic device;
wherein upon launching the software program, the software program automatically, instantly, and immediately downloads data from the first electronic device to the at least one additional electronic device.

6. The data transfer software application of claim 1 and further comprising:
a plurality of additional electronic devices, the software program downloaded on each of the additional electronic devices;
wherein upon launching the software program, the software program automatically, instantly, and immediately downloads data from the first electronic device to each of the additional electronic devices.

7. The data transfer software application of claim 1 wherein the software program is launched by means of WiFi, cell towers, satellite, Bluetooth, or Cloud.

8. The data transfer software application of claim 1 wherein the second electronic device is a server from a cellular provider if no other device or web site is available for use by the first electronic device.

9. The data transfer software application of claim 1 wherein the transferred data is selected from the group consisting of emails, texts, pictures, songs, videos, phone numbers, call records, web searches, fingerprints, and passcodes.

10. The data transfer software application of claim 1 wherein particular data immediately transmitted and interchanged between the first electronic device and the second electronic device is selectable in a parameter setting, enabling defining of data items to be transmitted and stored.

11. The data transfer software application of claim 1 wherein the software program links to a master web page enabling switching of transmitting and receiving capabilities between the first electronic device and the second electronic device, the master web page storing all information from both devices and any subsequently added devices.

12. The data transfer software application of claim 1 wherein the software program includes a Global Positioning System such that when the first electronic device is lost or stolen, a virtual ping is emitted from the first electronic device to the second electronic device, the GPS location of the first electronic device being displayed on the second electronic device.

13. A method for transmitting data, the method comprising:
providing a first electronic device;
providing a second electronic device;
downloading a software program on the first electronic device and the second electronic device;
launching the software program; and
automatically, instantly, and immediately downloads data from the first electronic device to the second electronic device.

14. A data transfer software application for transmitting data, the data transfer software comprising:
a first electronic device;
a second electronic device; and
a software program downloaded on the first electronic device and the second electronic device;
wherein the software program monitors the location and content of the first electronic device;
wherein upon launching the software program, the software program automatically, instantly, and immediately downloads data from the first electronic device to the second electronic device; and
wherein particular data immediately transmitted and interchanged between the first electronic device and the second electronic device is selectable in a parameter setting, enabling defining of data items to be transmitted and stored.

15. The data transfer software application of claim 14 wherein the first electronic device is a smartphone.

16. The data transfer software application of claim 14 wherein the second electronic device is selected from the group consisting of a smartphone, a tablet, a laptop, and a computer.

17. The data transfer software application of claim 14 and further comprising:
at least one additional electronic device, the software program downloaded on the at least one additional electronic device;
wherein upon launching the software program, the software program automatically, instantly, and immediately downloads data from the first electronic device to the at least one additional electronic device.

18. The data transfer software application of claim 14 and further comprising:
a plurality of additional electronic devices, the software program downloaded on each of the additional electronic devices;
wherein upon launching the software program, the software program automatically, instantly, and immediately downloads data from the first electronic device to each of the additional electronic devices.

19. The data transfer software application of claim 14 wherein the transferred data is selected from the group consisting of emails, texts, pictures, songs, videos, phone numbers, call records, web searches, fingerprints, and passcodes.

20. The data transfer software application of claim 14 wherein the software program links to a master web page enabling switching of transmitting and receiving capabilities between the first electronic device and the second electronic device, the master web page storing all information from both devices and any subsequently added devices.
